(19) United States
(12) Patent Application Publication
(10) Pub. No.: US 2014/0186606 A1
(43) Pub. Date: Jul. 3, 2014

(54) BALANCED AND LOW HEAT SHRINKAGE SEQUENTIALLY BIAXIALLY ORIENTED POLYETHYLENE TEREPHTHALATE FILM AND PROCESS FOR PRODUCING THE SAME

(71) Applicant: TORAY PLASTICS (AMERICA), INC., N. Kingstown, RI (US)

(72) Inventors: Douglas J. BOWER, North Kingstown, RI (US); Robert Thomas ERVOLINO, North Kingstown, RI (US)

(73) Assignee: TORAY PLASTICS (AMERICA), INC., N. Kingstown, RI (US)

(21) Appl. No.: 14/145,412

(22) Filed: Dec. 31, 2013

Related U.S. Application Data
(60) Provisional application No. 61/747,729, filed on Dec. 31, 2012.

(51) Int. Cl. C08G 63/183; B29D 7/01

(52) U.S. Cl. CPC C08G 63/183; B29D 7/01
USPC 428/220; 264/210.7; 528/308.1

(57) ABSTRACT

Described are methods for producing a sequentially biaxially oriented thermoplastic film having balanced machine direction (MD) and transverse direction (TD) heat shrinkage properties. The methods can include extruding a film, orienting the extruded film in a machine direction, quenching the film, heating the film in an transverse orientation oven and transversely orienting the film, and allowing the film to relax in the machine direction at a machine direction tension lower than a machine direction tension of the film in the transverse orientation oven.

### CROSS-REFERENCE TO RELATED APPLICATION

This application claims the benefit of U.S. Provisional Application Ser. No. 61/747,729, filed Dec. 31, 2012, the entire contents of which are incorporated herein by reference.

### FIELD OF THE INVENTION

This invention relates to biaxially oriented polyethylene terephthalate (PET) films having low machine direction (MD) heat shrinkage and also balanced MD to transverse (TD) heat shrinkage in a high temperature range and processes for manufacturing such films in-line.

### BACKGROUND OF THE INVENTION

It is common in the polyester film industry to produce bi-axially oriented films that have balanced, or equal, machine direction (MD) and transverse direction (TD) heat shrinkage properties, typically 1.5% shrinkage at temperature of 150° C. for 30 minutes and 2% at temperature of 190° C. for 5 minutes.

In a sequentially biaxially oriented polyethylene terephthalate (PET) film manufacturing line, the PET is extruded through a slot die and is electrostatically pinned to a chilled roller to produce a continuously moving, solid, amorphous film sheet. This sheet is oriented in two separate processes-in a first process, the sheet travels through a set of heated rollers and is then drawn 3 to 5 times in the machine direction by rollers rotating at different speeds, the sheet is then quenched using cooled rollers; and in a second process the sheet travels into an enclosed oven and is preheated above glass transition temperature 90° C., it is then oriented 3 to 5 times at approximately 165° C., then heat set at about 240° C., and after heat setting the film may be allowed to relax in the transverse direction.

A method to produce biaxially oriented films with controlled TD heat shrinkage properties is known. However, the process for specifically controlling heat shrinkage in a sequentially orienting film manufacturing line is only available in the TD, using the TD orienting oven rail system where the distance in the relax region is less than the TD distance of the heat set region.

After the film is biaxially oriented and heat set in an enclosed oven, the edge must be trimmed and the continuous sheet wound into a roll. Typically a machine containing driven rollers contains the edge trimming equipment. This trimming machine runs at an equivalent speed to the TD orienting oven to maintain control of the sheet for stable trimming conditions without tearing and stable winding tension for acceptable wound roll formation. In common sequentially oriented thermoplastic film manufacturing lines, the MD heat shrinkage value at higher temperature of 150° C. after 30 minutes is greater than 1.0% and the MD heat shrinkage value at a temperature of 190° C. after 5 minutes is greater than 2.0%. This is because there is no provision to allow any relax in the machine direction at the appropriate temperature due to the fixed chain link and clip MD distance design of the orienting oven and the need to maintain machine direction tension in the manufacturing line after the sheet is released from the orienting oven chain system to convey the film sheet through the process, which does not allow proper relaxing for low MD heat shrinkage.

Controlling the heat set temperature is an available method to control not only TD heat shrinkage but also MD heat shrinkage. However, using higher temperatures that are close to the film's melting point causes the film to sag due to the film's own weight. This can result in large TD and MD heat shrinkage.

In-line or off-line annealing treatments are also available to control MD heat shrinkage. However, the former requires a large space after the enclosed oven process. This is because a long web pass length is required to increase the residence time in the in-line annealing instrument. Further, off-line annealing equipment requires a large capital investment, additional floor space and additional labor. Both treatments require a larger amount of electricity.

Accordingly, to achieve dimensional stability at elevated temperatures, the sequential biaxially oriented films must be processed off line, using an additional annealing step at additional cost and time. Care also must be taken to control inner roll temperature gradient for consistent properties and roll formation quality issues such as wrinkling, blocking or buckling.

Simultaneous stretch processes are able to produce low and balanced, thermally stable heat shrinkage biaxially oriented PET films—however, these processes require a different process and a specialized oven that has variable machine direction distance between each chain link and the clips and must be capable to relax the oriented and heat set film in the machine direction at the appropriate temperature.

### SUMMARY OF THE INVENTION

Described are biaxially oriented polyethylene terephthalate (PET) films having low machine direction (MD) heat shrinkage and also balanced MD to transverse (TD) heat shrinkage in a high temperature range and processes for manufacturing such films in-line. In some embodiments, the films have a low MD heat shrinkage at a higher 150° C. to 190° C. temperature range to achieve balanced heat shrinkage using an in-line process for biaxially oriented polyethylene terephthalate (PET) films with no subsequent post processing.

An embodiment of an in-line method for producing a sequentially biaxially oriented thermoplastic film having a balanced machine direction (MD) and transverse direction (TD) heat shrinkage property of less than 1.0% at 150° C. after 30 minutes, preferably less than 0.5% at 150° C. after 30 minutes, includes extruding a thermoplastic film, orienting the extruded thermoplastic film in a machine direction, quenching the thermoplastic film, heating the thermoplastic film in a transverse orientation oven and transversely orienting the film, and allowing the film to relax in the machine direction after the transverse orientation oven at a tension that is lower than the machine direction tension of the film in the transverse orientation oven. In some embodiments the tension is between 2 and −1 kg/m, more preferably between 1 and −1 kg/m.

An embodiment of an in-line method for producing a sequentially biaxially oriented thermoplastic film having a balanced machine direction (MD) and transverse direction (TD) heat shrinkage property of less than 2.0% at 190° C. after 5 minutes, preferably less than 1.7% at 190° C. after 5 minutes, includes extruding a thermoplastic film, orienting the extruded thermoplastic film in a machine direction, quenching the thermoplastic film, heating the thermoplastic film in an transverse orientation oven and transversely orienting the film, and allowing the film to relax in the machine direction at a low tension after the transverse orientation oven.

The sequentially biaxially oriented thermoplastic film may be a polyethylene terephthalate (PET) film having a thickness of 4 μm to 75 μm. Preferably the film thickness is 20 μm to 50 μm. Infra-red heaters may be used to control film temperature during the machine direction relax process.

In some embodiments, an in-line method for producing a sequentially biaxially oriented thermoplastic film having balanced machine direction (MD) and transverse direction (TD) heat shrinkage properties includes extruding a film, orienting the extruded film in a machine direction, quenching the film, heating the film in an transverse orientation oven and transversely orienting the film, and allowing the film to relax in the machine direction at a machine direction tension lower than a machine direction tension of the film in the transverse orientation oven.

In some embodiments, the film has less than 1.0% shrinkage at 150° C. after 30 minutes. In some embodiments, the film has less than 2.0% shrinkage at 190° C. after 5 minutes. In some embodiments, the film has a minute endothermic peak temperature (Tmeta) of less than 245° C. In some embodiments, the film comprises polyester terephthalate (PET). In some embodiments, the biaxially oriented film has a thickness of 4 μm to 75 μm. In some embodiments, infra-red heaters are used to control film temperature during the machine direction relax process. In some embodiments, the biaxially oriented thermoplastic film is oriented 3 to 5 times in the machine direction and 3 to 5 times in the traverse direction.

In some embodiments, the method includes transporting the film through a nip and roll combination of rollers to reduce the tension of the film in the machine direction during the machine direction relax process. In some embodiments, the method includes transporting the film through a high friction roll on which there is a wrap angle of at least 120 degrees to reduce the tension of the film in the machine direction during the machine direction relax process. In some embodiments, the method includes transporting the film through a hollow perforated roller that has a lower than atmosphere internal pressure.

In some embodiments, a method for relaxing a film in a machine direction following a biaxial orientation process includes orienting a film in a machine direction, heating the film in an transverse orientation oven and transversely orienting the film, and relaxing the biaxially oriented film in a machine direction by feeding the film through a tension separating roller system comprising a nip and roll combination, a high friction roll on which there is a wrap angle of at least 120 degrees, or a hollow perforated roller that has a lower than atmosphere internal pressure, wherein a speed the tension roller system is controlled to produce a machine direction film speed following the tension separating roller system that is less than a machine direction film speed in the transverse orientation oven.

In some embodiments, a biaxially oriented film is produced by a method including extruding a film, orienting the extruded film in a machine direction, quenching the film, heating the film in an transverse orientation oven and transversely orienting the film, and allowing the film to relax in the machine direction at a machine direction tension lower than a machine direction tension of the film in the transverse orientation oven.

### BRIEF DESCRIPTION OF THE DRAWINGS

Exemplary embodiments of the invention will now be described with reference to the accompanying drawings, in which:

FIG. 1 illustrates a tension separating device using a nip and roll combination according to embodiments.

FIG. 2 illustrates a tension separating using high friction roll according to embodiments.

FIG. 3 illustrates a tension separating device using a tension cut vacuum roll according to embodiments.

### DETAILED DESCRIPTION OF THE INVENTION

Described are methods of producing a film with a low MD heat shrinkage in a temperature range of from 150° C. to 190° C. to achieve balanced heat shrinkage. This process is an in-line process, using a controlled MD relax ratio of greater than 0%, and uses a tension cut process in the MD direction during the conveyance of the film sheet after MD and TD orientation, and after heat setting and TD relax is completed. Also described are films produced using these methods.

In some embodiments, the methods can be carried out in a sequential bi-axially oriented in-line process that does not use a specialized oven, and uses a combination of speed control of the rollers located post orienting oven and a tension separating technique between the rollers and the finished winding roll to allow the film sheet to relax in the machine direction during free-span conveyance at a low tension after the oven. The post-oven rollers are at a specific speed relative to the oven speed, and the amount of film shrinkage is such that the slack due to speed variance is consumed by the shrinkage of the film. A higher tension after the tension separation is maintained for good edge trimming and desirable winding quality of the finished roll.

In some embodiments, the tension cut created between the oven and the final winding roll is located in the transporting rollers between the oven and the final winding roll and can be achieved by using a nip and roll combination, or a high friction roll on which there is a wrap angle at least 120 degrees, or a hollow perforated roller that has a lower than atmosphere internal pressure, one of which combined with a variable, controlled speed of the tension separating roller, which is set to a speed less than the machine direction speed of the oven.

The film temperature during the free span is maintained at, for example, at 200 degrees ° C., by the heat transfer of the heated air in the oven enclosure, or by IR heaters, either alone or in combination, such that the desired shrinkage and thermal stability properties are realized. In some embodiments, the temperature is maintained between 145° C. and 160° C., or between 185° C. and 200° C.

In some embodiments of a sequentially biaxially oriented PET film manufacturing line, the PET polymer is extruded through a slot die and is electrostatically pinned to a chilled roller to produce a continuously moving, solid, amorphous film sheet. This amorphous sheet is oriented in two separate and distinct processes. First, the sheet travels through a set of heated rollers and is then drawn 3 to 5 times in the machine direction by rollers rotating at different speeds. The sheet is then quenched using cooled rollers. In a second orientation process the machine direction oriented sheet travels into an enclosed oven using, for example, a pair of fixed link chains with attached clips (one for each side of sheet) that grasp the film sheet edges. The chain, which can be driven by a speed controlled motor, pulls the MD oriented sheet into the TD orienting oven, and the sheet is preheated above glass transition temperature. In some embodiments, the sheet is heated to at least 85° C., to at least 95° C. to at least 110° C., or to approximately 90° C. The sheet is then transversally drawn by 3 to 5 times at, for example, approximately 115° C. to 140° C., 140° C. to 165° C., 165° C. to 190° C. or approximately 165° C. The film is then heat set at about 240° C. and after heat setting may be allowed to relax in the transverse direction.

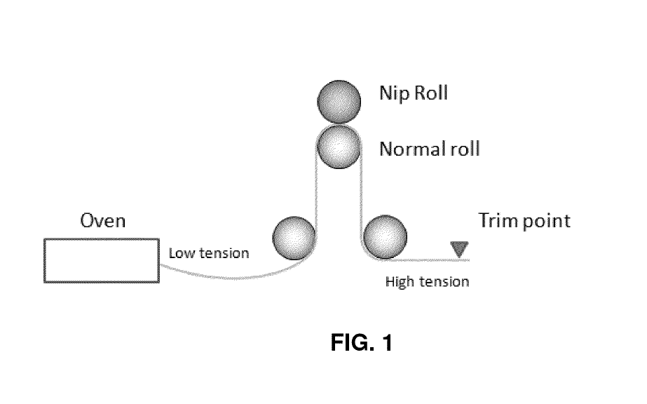

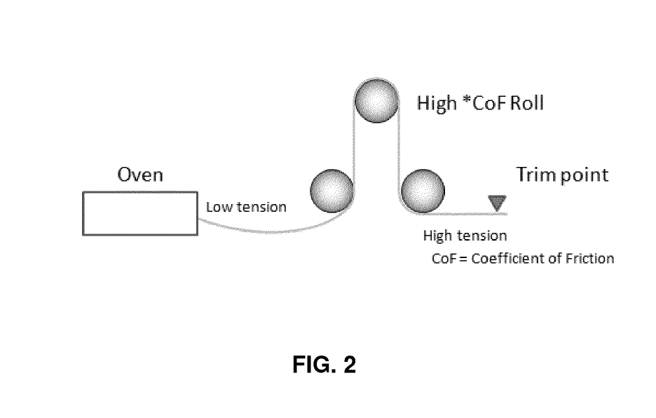

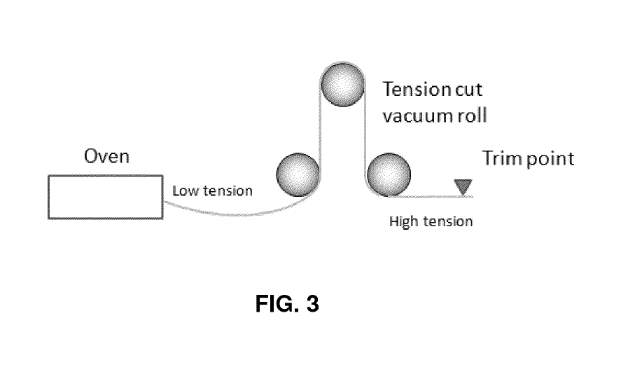

After the TD orienting oven, the sequentially biaxially oriented film passes through a set of rollers to eliminate wrinkles and maintain flatness for acceptable edge trimming quality. The sheet is then sent into a tensioned winding machine for acceptable wound film quality as is standard practice in the industry. To control the MD heat shrinkage, machine direction web tension is separated between the oven and the final winding roll and is located in the transporting rollers between the oven and the final winding roll and can be achieved using a nip and roll combination, a high friction roll on which there is a web wrap angle at least 120 degrees, or a hollow perforated roller that has a lower than atmosphere internal pressure, combined with a controllable speed tension separating roller, which is set to a speed less than the machine direction speed of the oven. FIG. 1 shows a tension separating device using a nip and roll combination. FIG. 2 shows a tension separating using high friction roll. In FIG. 2, the coefficient of static friction between the roller and the film surface is >1.0. FIG. 3 shows a tension separating device using a tension cut vacuum roll. In FIG. 3 the pressure inside the vacuum roll is less atmospheric pressure, for example it is less than atmospheric pressure by 10 to 20 inches H₂O.

This tension separating device allows low tension of the film sheet between the TD orienting oven and the tension separating roller for relax in the machine direction during free-span conveyance after the oven. The tension in the film in the machine direction after the transverse orientation oven is lower than the machine direction tension of the film in the transverse orientation oven. In some embodiments the tension is between 2 and −1 kg/m, more preferably between 1 and −1 kg/m. The film temperature during this free span can be maintained, for example, at 145° C. to 160° C., or at 185° C. to 200° C. or 190 to 200° C., by the heat transfer of the heated air in the oven enclosure, or by IR heaters, either alone or in combination, such that the desired shrinkage and thermal stability properties are realized. The post-oven rollers can be driven at a specific speed relative to the oven speed, using a speed controller set to a ratio of less than one relative to the TD orienting oven and the amount of film shrinkage so that the slack due to speed variance is consumed by the shrinkage of the film. In addition, then tension is maintained after the tension separating device higher tension is maintained for good edge trimming and desirable winding quality of the finished roll.

Films produced using these methods can have the following properties: a balanced machine direction (MD) and transverse direction (TD) heat shrinkage property of less than 1.0% at 150° C. after 30 minutes, preferably less than 0.5% at 150° C. after 30 minutes, a balanced machine direction (MD) and transverse direction (TD) heat shrinkage property of less than 2.0% at 190° C. after 5 minutes, preferably less than 1.7% at 190° C. after 5 minutes, a tensile strength in the MD of 150 to 400 MPa, a tensile strength in the TD of 150 to 400 MPa, an MD elongation of 75% to 220%, and a TD elongation of 80% to 200% in thickness range of 4 μm to 75 μm.

This invention will be better understood with reference to the following examples, which are intended to illustrate specific embodiments within the overall scope of the invention.

### Test Methods

Film Heat Shrinkage was measured at 150° C. for 30 minutes in accordance with ASTM D1204.

Film Heat Shrinkage was measured at 190° C. for 5 minutes in accordance with ASTM D1204.

Crystallization temperature (Tc) was measured by a differential scanning calorimetry (DSC).

Nucleation onset temperature (Tn) was measured by a differential scanning calorimetry (DSC).

Minute endothermic peak temperature (Tmeta) that was found between glass-transition temperature (Tg) and melting temperature (Tm) was measured by a differential scanning calorimetry (DSC).

### EXAMPLES

Comparative Example A is representative of current sequential biaxially oriented PET film made with no in-line machine direction relax control.

Comparative Example B is produced using the combination of speed control of the rollers located post orienting oven and a tension separating technique between the rollers and the finished winding roll to allow the film sheet to relax in the machine direction during free-span conveyance at a low tension after the TD orienting oven, having a machine direction relax ratio of 0.050%.

Comparative Example C is produced using the combination of speed control of the rollers located post orienting oven and a tension separating technique between the rollers and the finished winding roll to allow the film sheet to relax in the machine direction during free-span conveyance at a low tension after the TD orienting oven, having a machine direction relax ratio of 0.503%.

TABLE 1
Relax Ratio

| | MD Relax | TD Relax |
|---|---|---|
| | Ratio | Ratio |
| Comparative | 0.000% | 2.40% |
| Example A | | |
| Comparative | 0.050% | 2.40% |
| Example B | | |
| Example C | 0.503% | 2.40% |

Table 1 shows that MD relax ratio is set differently by each example without the changing of TD relax ratio.

TABLE 2
150° C. 30 Minute Heat Shrinkage

| | 150° C. 30 | 150° C. 30 |
|---|---|---|
| | Minute MD | Minute TD |
| | Heat | Heat |
| | Shrinkage | Shrinkage |
| Comparative | 2.00% | 0.40% |
| Example A | | |
| Comparative | 0.80% | 0.40% |
| Example B | | |
| Example C | 0.40% | 0.40% |

Table 2 shows that the improvement of MD heat shrinkage at 150 C×30 min could be found without the changing of TD heat shrinkage.

TABLE 3
190° C. 5 Minute Heat Shrinkage

| | 190° C. after 5 | 190° C. after |
|---|---|---|
| | Minutes MD | 5 Minutes |
| | Heat | TD Heat |
| | Shrinkage | Shrinkage |
| Comparative | 2.00% | 1.00% |
| Example A | | |
| Comparative | 1.40% | 1.00% |
| Example B | | |
| Example C | 1.20% | 1.00% |

Table 3 shows that the improvement of MD heat shrinkage at 190 C×5 min could also be found without the changing of TD heat shrinkage.

TABLE 4
Crystallization temperature (Tc), nucleation onset temperature (Tn)
and minute endothermic peak temperature (Tmeta)

| | Tc | Tn | Tmeta |
|---|---|---|---|
| Comparative | 201° C. | 209° C. | 244° C. |
| Example A | | | |
| Comparative | 195° C. | 208° C. | 242° C. |
| Example B | | | |
| Example C | 195° C. | 208° C. | 242° C. |

Table 4 shows that MD low heat shrinkage is achieved without higher heat set temperature and without specific materials or additives with positive thermal specification that reduce heat shrinkage. All examples have nearly the same Tmeta which shows that the heat set temperature of each example is the same. Additionally, the Tc and Tn values show that the thermal specification of the component materials in each example is the same.

The above description includes several numerical ranges in the text and figures. The numerical ranges support any range or value within the disclosed numerical ranges even though a precise range limitation is not stated verbatim in the specification because embodiments of the invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. The entire disclosure of the patents and publications referred in this application are hereby incorporated herein by reference. Finally, the invention can be construed according to the claims and their equivalents.

1. An in-line method for producing a sequentially biaxially oriented thermoplastic film having balanced machine direction (MD) and transverse direction (TD) heat shrinkage properties comprising:
extruding a film;
orienting the extruded film in a machine direction;
quenching the film;
heating the film in an transverse orientation oven and transversely orienting the film; and
allowing the film to relax in the machine direction at a machine direction tension lower than a machine direction tension of the film in the transverse orientation oven.

2. The method of claim 1, wherein the film has less than 1.0% shrinkage at 150° C. and 30 minutes.

3. The method of claim 1, wherein the film has less than 2.0% shrinkage at 190° C. after 5 minutes.

4. The method of claim 1, wherein the film has a minute endothermic peak temperature (Tmeta) of less than 245° C.

5. The method of claim 1, wherein the film comprises polyester terephthalate (PET).

6. The method of claim 1, wherein the biaxially oriented film has a thickness of 4 μm to 75 μm.

7. The method of claim 1, wherein infra-red heaters are used to control film temperature during the machine direction relax process.

8. The method of claim 1, wherein the biaxially oriented thermoplastic film is oriented 3 to 5 times in the machine direction and 3 to 5 times in the traverse direction.

9. The method of claim 1, comprising transporting the film through a nip and roll combination of rollers to reduce the tension of the film in the machine direction during the machine direction relax process.

10. The method of claim 1, comprising transporting the film through a high friction roll on which there is a wrap angle of at least 120 degrees to reduce the tension of the film in the machine direction during the machine direction relax process.

11. The method of claim 1, comprising transporting the film through a hollow perforated roller that has a lower than atmosphere internal pressure.

12. A method for relaxing a film in a machine direction following a biaxial orientation process comprising:
orienting a film in a machine direction;
heating the film in an transverse orientation oven and transversely orienting the film; and
relaxing the biaxially oriented film in a machine direction by feeding the film through a tension separating roller system comprising a nip and roll combination, a high friction roll on which there is a wrap angle of at least 120 degrees, or a hollow perforated roller that has a lower than atmosphere internal pressure, wherein a speed the tension roller system is controlled to produce a machine direction film speed following the tension separating roller system that is less than a machine direction film speed in the transverse orientation oven.

13. The method of claim 12, wherein the film has less than 1.0% shrinkage at 150° C. after 30 minutes.

14. The method of claim 12, wherein the film has less than 2.0% shrinkage at 190° C. after 5 minutes.

15. The method of claim 12, wherein the film has a minute endothermic peak temperature (Tmeta) of less than 245° C.

16. The method of claim 12, wherein the film comprises polyester terephthalate (PET).

17. The method of claim 12, wherein the film has a thickness of 4 μm to 75 μm.

18. The method of claim 12, wherein infra-red heaters are used to control film temperature during the machine direction relax process.

19. The method of claim 12, wherein the biaxially oriented thermoplastic film is oriented 3 to 5 times in the machine direction and 3 to 5 times in the traverse direction.

20. The method of claim 12, wherein the tension separating roller system comprises the nip and roll combination.

21. The method of claim 12, wherein the tension separating roller system comprises the high friction roll on which there is a wrap angle of at least 120 degrees.

22. The method of claim 12, wherein the tension separating roller system comprises the hollow perforated roller that has a lower than atmosphere internal pressure.

23. A biaxially oriented film produced by a method comprising:
extruding a film;
orienting the extruded film in a machine direction;
quenching the film;
heating the film in an transverse orientation oven and transversely orienting the film; and
allowing the film to relax in the machine direction at a machine direction tension lower than a machine direction tension of the film in the transverse orientation oven.

24. The film of claim 23, wherein the film has less than 1.0% shrinkage at 150° C. after 30 minutes.

25. The film of 23, wherein the film has less than 2.0% shrinkage at 190° C. after 5 minutes.

26. The film of claim 23, wherein the film has a minute endothermic peak temperature (Tmeta) of less than 245° C.

27. The film of claim 23, wherein the film comprises polyester terephthalate (PET).

28. The film of claim 23, wherein the biaxially oriented film has a thickness of 4 μm to 75 μm.
